(19) United States
(12) Patent Application Publication
(10) Pub. No.: US 2020/0103030 A1
(43) Pub. Date: Apr. 2, 2020

(54) GASKET AND SANITARY EQUIPMENT

(71) Applicant: LIXIL Corporation, Tokyo (JP)

(72) Inventors: Tsubasa FURUHASHI, Tokyo (JP); Yousuke BAN, Tokyo (JP); Kouji FUKUYA, Tokyo (JP); Takahiro NODA, Tokyo (JP); Reo SEIKE, Tokyo (JP)

(73) Assignee: LIXIL Corporation, Tokyo (JP)

(21) Appl. No.: 16/584,393

(22) Filed: Sep. 26, 2019

(30) Foreign Application Priority Data
Sep. 28, 2018 (JP) 2018-183985

(51) Int. Cl. F16J 15/08; E03D 11/13

(52) U.S. Cl. CPC F16J 15/0818; E03D 11/13

(57) ABSTRACT

Provided is a gasket capable of reducing the risk of water leakage from a sealing member for use to join a ceramic member. The gasket is made of elastic material and usable for joining two members which form a flow passage for liquid, and at least one of which is a ceramic member. The gasket includes: a base having a loop shape; a protrusion standing on the base, extending along the loop shape, and protruding toward one of the members; and a retainer formed on an inner periphery of the base and protruding from the inner periphery in an inward direction with respect to the loop shape.

### CROSS-REFERENCE TO RELATED APPLICATIONS

This application claims the priority of Japanese Patent Application No. 2018-183985, filed Sep. 28, 2018, the entire contents of which are incorporated herein by reference.

### BACKGROUND OF THE INVENTION

The present disclosure relates to a gasket and sanitary equipment.

JP2017-48551A discloses a flush toilet bowl provided with a resin trap. In this toilet bowl, a butyl rubber gasket is used in order to join the resin trap and the ceramic toilet bowl to each other and to block a gap so as to prevent water leakage from the joint.

However, at the time of assembling the resin trap to the ceramic toilet bowl, the resin trap may be deformed in a direction in which the gasket is pulled and removed. In addition, butyl rubber and a ceramic product may not adhere to each other sufficiently when dust or water drops penetrate the interface between them.

### SUMMARY OF THE INVENTION

The present disclosure has been made in view of the foregoing background, and provides a gasket capable of reducing the risk of water leakage from a sealing member for use to join a ceramic member.

The present disclosure provides a gasket (e.g., a gasket 1 to be described later) made of an elastic material and usable for joining two members which form a flow passage (e.g., a drain passage 5 to be described later) for liquid, and at least one of which is a ceramic member (e.g., a ceramic member 2 to be described later). The gasket includes: a base (e.g., a base 11 to be described later) having a loop shape; a protrusion (e.g., a first protrusion 12 to be described later) standing on the base, extending along the loop shape, and protruding toward one of the members; and a retainer (e.g., a retainer 14 to be described later) formed on an inner periphery of the base and protruding from the inner periphery in an inward direction with respect to the loop shape.

### BRIEF DESCRIPTION OF THE DRAWINGS

FIG. 1 is a diagram showing a location at which a gasket 1, according to some embodiments, is used;

FIG. 2A is a top view of the gasket 1, according to some embodiments;

FIG. 2B is a cross-sectional view of a large curvature portion of the gasket 1, according to some embodiments;

FIG. 2C is a cross-sectional view of a substantially straight portion of the gasket 1 according to some embodiments;

FIG. 3 is a diagram showing the gasket 1 that has been assembled to a resin member 3, according to some embodiments;

FIG. 4 is a cross-sectional view of the large curvature portion of the gasket 1, and shows the gasket 1 and joinable members that are yet to be assembled together, according to some embodiments;

FIG. 5 is a cross-sectional view of the large curvature portion of the gasket 1, and shows the gasket 1 and the joinable members that have been assembled together, according to some embodiments; and

FIG. 6 is a cross-sectional view of the substantially straight portion of the gasket 1, and shows the gasket 1 and the joinable members that are yet to be assembled together, according to some embodiments.

### DETAILED DESCRIPTION OF THE INVENTION

Embodiments of the present disclosure will be described below. Note that the present disclosure is not limited the following embodiments.

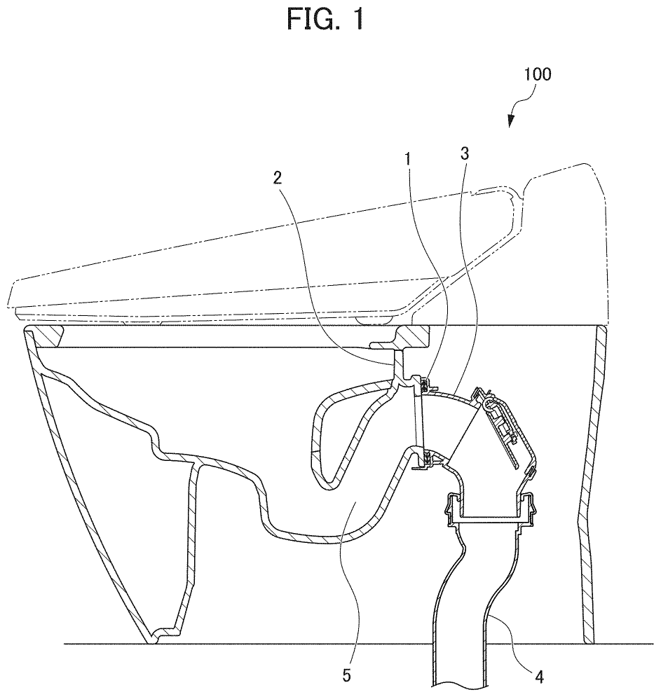

FIG. 1 is a diagram showing a location at which a gasket 1, according to some embodiments, is used. A toilet bowl 100 according to some embodiments includes a ceramic member 2, a resin member 3, and a drain socket 4, which are joined to one another to form a drain passage 5 having a substantially rectangular tubular shape. The gasket 1 is provided at the joint between the ceramic member 2 and the resin member 3.

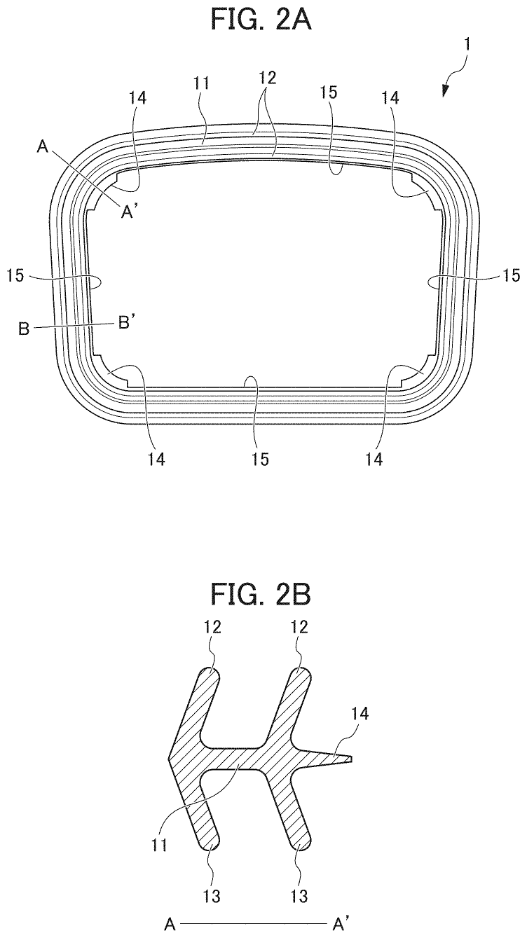

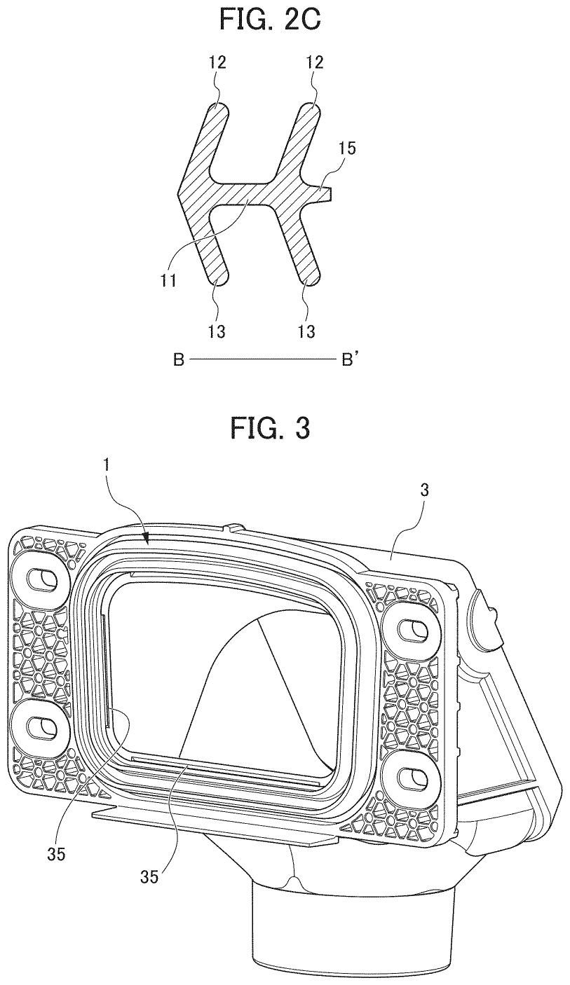

FIG. 2A is a top view of the gasket 1 according to some embodiments. FIGS. 2B and 2C are cross-sectional views of a large curvature portion and a substantially straight portion of the gasket 1 according to some embodiments, respectively. The gasket 1 according to some embodiments is intended for a flush toilet bowl and is usable to join the ceramic member 2 to the resin member 3. The gasket 1 includes a base 11 having a loop shape, first protrusions 12, second protrusions 13, retainers 14, and projections 15. The first protrusions 12 and the second protrusions 13 protrude from the base 11 toward different ones of the joinable members, and extend along the loop shape.

The gasket 1 is made of an elastic material. For example, the gasket 1 may be made of a material generally used to form a sealing packing or a gasket, such as ethylene-propylene-diene-methylene (EPDM) rubber. The base 11 has the shape of a substantially rectangular loop. However, the shape of the loop is not limited to the substantially rectangular shape, and may be any shape as desired, such as a true circle, an ellipse, or a polygon, depending on the shape of the flow passage formed by the joinable members.

Having the first protrusions 12 and the second protrusions 13, the gasket 1 deforms significantly to generate a repulsive force when sandwiched between the joinable members. As a result, gasket 1 exhibits a high sealability with respect to the joinable members, with the help of a surface pressure. Here, a ceramic material is likely to have fine unevenness on its surface. The gasket 1 implements surface pressure sealing by which the gasket 1 easily fits with the unevenness, thereby achieving sufficient sealability.

FIG. 3 is a diagram showing the gasket 1 that has been assembled to the resin member 3. The retainers 14 are formed only in portions of the inner periphery of the base 11, specifically, at the four corners of the substantially rectangular base 11. The retainers 14 retain the gasket 1 at the resin member 3 with a weak force when the ceramic member 2 and the resin member 3 are assembled together. This facilitates assembly of the gasket 1 to the resin member 3.

In the loop shape described above, the area in which the retainers 14 are formed is suitably determined such that the gasket 1 is retained to an extent that handling at the time of assembling can be performed sufficiently easily. This is because while the strength with which the gasket 1 is retained to the resin member 3 can be increased with increase in the area, the likelihood of causing a strain in the gasket 1 is enhanced with increase in the strength with which the gasket 1 is retained. For example, it is suitable that the retainer 14 is formed at least one of the four corners of the substantially rectangular base 11 shown in FIG. 2A.

Each projection 15 is provided in a portion, of the inner periphery of the base 11, in which the retainer 14 is absent, and projects from the base 11 in an inward direction with respect to the base 11 to be shorter in the inward direction than the retainer 14. The projection 15, which is formed to be short, does not act in contact with the other of the joinable members, unlike the retainer 14. However, the formation of the projection 15 increases the strength of the gasket 1, and enhances the repulsive force.

In some embodiments, the joinable members include the ceramic member 2 and the resin member 3. However, as long as one of the joinable members is made of a ceramic material and can be joined by means of the gasket 1 of some embodiments, the material for the other of the joinable members is not limited to resin. For example, the material for the other of the joinable members may be metal or ceramic.

FIG. 4 is a cross-sectional view of the large curvature portion of the gasket 1, and shows the gasket 1 and the joinable members that are yet to be assembled together. The resin member 3 includes a receiving portion 31 that can receive therein the first protrusions 12 and the second protrusions 13 in a state where the joinable members have been joined to each other with the gasket 1 sandwiched between the joinable members. The receiving portion 31 is defined by an inner wall 32 that forms the drain passage 5 in the resin member 3, an outer wall 33 that surrounds the outer periphery of the inner wall 32, and a bottom 34 that directly connects the inner wall 32 to the outer wall 33.

At the time of the assembly, the gasket 1 is sandwiched while having the first protrusions 12 in contact with the bottom 34 and the second protrusions 13 in contact with the ceramic member 2. The retainers 14 of the gasket 1 are received in the receiving portion 31 while being caught by the inner wall 32, thereby enabling the gasket 1 to be retained to the resin member 3.

In the receiving portion 31, the inner wall 32 and the outer wall 33 have the same height from the bottom 34. The height of the inner and outer walls 32 and 33 from the bottom 34 is equal to the distance from the tip end of the first protrusion 12 to the base 11 of the gasket 1. In the gasket 1, the distance from the tip end of the first protrusion 12 to the base 11 is equal to the distance from the tip end of the second protrusion 13 to the base 11. As a result, the top end surface of the inner wall 32 and the top end surface of the outer wall 33 are both butted against an end surface of the ceramic member 2, and the gasket 1 comes to have an amount of flattening of 50%, thereby achieving sufficient sealability.

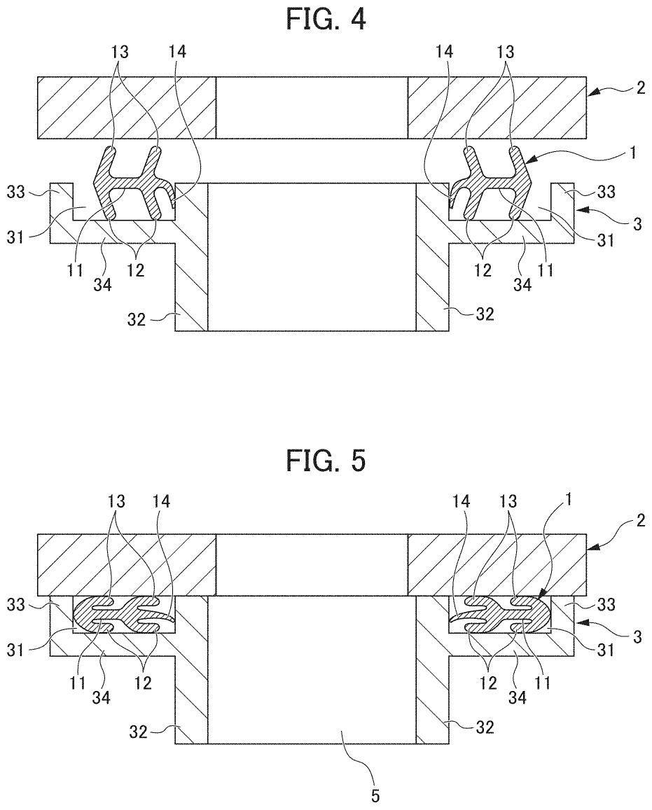

FIG. 5 is a cross-sectional view of the large curvature portion of the gasket 1, and shows the gasket 1 and the joinable members that have been assembled together. The first protrusions 12 and the second protrusions 13 are significantly deformed by being sandwiched between, and pressed by, the joinable members, and consequently generate a repulsive force, which in turn generates a large surface pressure, thereby improving the sealability of the gasket 1. The first protrusions 12 and the second protrusions 13 are inclined in the inward direction with respect to the loop shape such that each of the first protrusion 12 and the associated second protrusion 13 form an angle of 140°. This feature allows the gasket 1 to achieve more sufficient sealability.

Here, since the retainers 14 are formed only at the four corners of the substantially rectangular shape, the straight portions of the substantially rectangular shape are not caught on the inner wall 32, so that the gasket 1 is not restrained at these straight portions. As a result, a strain is less likely to arise in the straight portions of the gasket 1, thereby enabling reduction of the risk of water leakage.

More specifically, since the retainers 14 retain the gasket 1 to the resin member 3 with a weak force, the deformation of the gasket 1 is limited to a certain extent. Limiting the deformation of the gasket 1 when the gasket 1 is sandwiched between the joinable members may cause a strain in the gasket 1 and make it impossible to obtain sufficient sealability. In view of this, the retainers 14 are provided only in portions of the loop shape so that the loop shape has a region in which the gasket 1 is allowed to deform without being restrained. In this manner, the strain is reduced, and the risk of water leakage can be reduced.

If the loop shape is not circular, the strength of the gasket 1 against strain is not uniform over the entire loop shape. In other words, if the retainer 14 extends over the entire inner periphery of the gasket 1, a strain is likely to arise in a portion having a low strength against strain.

Therefore, selectively providing the retainers 14 only in portions of the loop shape that have a relatively high strength against strain makes it possible to effectively reduce the risk of water leakage. In particular, the strength against strain is high in a portion having a large curvature. For example, in the substantially rectangular gasket 1 of some embodiments, the strength against strain is high at the four corners and low in the straight portions. Therefore, the retainers 14 are provided at the four corners.

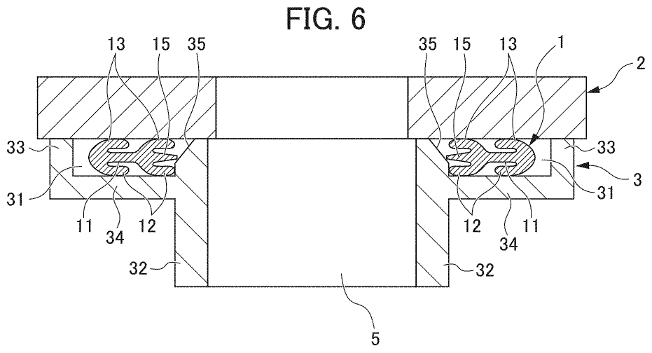

FIG. 6 is a cross-sectional view of the substantially straight portion of the gasket 1, and shows the gasket 1 and the joinable members that are yet to be assembled together. The resin member 3 is provided with chamfered portions 35 that each correspond to a portion, of the gasket 1, in which the projection 15 is formed. The chamfered portions 35 formed on the inner wall 32 make it easy to guide the projections 15 into the receiving portion 31 when the gasket 1 is assembled to the resin member 3. As a result, the projections 15 are less likely to come into contact with the inner wall 32, so that a cause of the strain in the gasket 1 can be substantially eliminated and the risk of water leakage can be reduced further.

As can be seen, the gasket 1 according to some embodiments brings about the following effects.

The retainers 14 are provided only in the large curvature portions of the loop shape, the large curvature portions having a larger curvature than the other portions. Thus, since the retainers 14 are provided only in the portions where strain is less likely to arise, the risk of water leakage is reduced further.

The base 11 has a substantially rectangular shape, and the retainers 14 are provided at four corners of the base 11. As a result, the gasket can be provided which reduces the risk of water leakage from the drain passage 5 formed in a substantially rectangular shape in order to ensure a suitable flow rate in a flush toilet bowl.

The protrusions include the first protrusions 12 protruding toward one of the joinable members and the second protrusions 13 protruding toward another of the joinable members. The second protrusions 13 are positioned adjacent to the ceramic member 2. This feature enables surface pressure sealing to be achieved on both sides of the gasket 1, thereby improving the sealability. Further, satisfactory sealing can be achieved even with respect to the ceramic member whose surface is likely to have fine unevenness.

The receiving portion 31 is defined by the inner wall 32 forming the drain passage 5, the outer wall 33 surrounding the outer periphery of the inner wall 32, and the bottom 34 directly connecting the inner wall 32 to the outer wall 33. The top end surface of the inner wall 32 and the top end surface of the outer wall 33 are butted against, and joined to, the end surface of the ceramic member 2. The shapes of these members and the sufficient sealability of the gasket 1 of the present disclosure enable butt-joining of the members. This feature increases a degree of flexibility of locations to which the gasket 1 of the present disclosure is applicable.

The gasket 1 has the chamfered portions corresponding to the portions, of the loop shape, that have the projections 15. This feature makes it less likely that the projections 15 come into contact with the inner wall 32, so that a cause of the strain in the gasket 1 can be substantially eliminated and the risk of water leakage can be reduced further.

As described above, the present disclosure provides a gasket that is capable of reducing the risk of water leakage from a sealing member for use to join a ceramic member. The use of the gasket of the present disclosure is not limited to flush toilet bowls. The gasket may be used in plumbing fixtures such as those in a lavatory, a bathroom, and a kitchen. The gasket is usable to join two members to each other, as long as at least one of the members is a ceramic member.

In some embodiments, the resin member 3 has the receiving portion 31. Alternatively, the ceramic member may have the receiving portion. It is preferable to develop a design in consideration of the size, the shape, and the like of the components such that desired ease of handling at the time of assembly is achieved. In addition, it is conceivable that the joinable members do not have the receiving portion, and the outer periphery of the gasket is exposed.

The protrusion is particularly effective at sealing the contact surface with a ceramic member that is likely to have unevenness. It is preferable to provide the protrusion at least on the side adjacent to the joinable member having the receiving portion, from the viewpoint of the contact with the joinable member. However, in a case where the ceramic member has the receiving portion, sufficient sealability can be obtained even with only the first protrusion provided on the side adjacent to the ceramic member. Nevertheless, in a case where the joinable members are both ceramic members, the first and second protrusions are both required.

In some embodiments, the drawings show that the first protrusion and the second protrusion each includes two protrusions. However, the number of each of the first and second protrusions is not particularly limited. However, in order to reduce the possibility of occurrence of a strain in the gasket having the loop shape, it is preferable that the number of the first protrusions and that of the second protrusions be equal to each other and that the protrusions be uniformly deformed with respect to both of the joinable members.

The joinable members of some embodiments are shaped such that the members are butt-joined to each other. However, the embodiments of the present disclosures are not limited to this. For example, one of the joinable members may be provided with a tubular portion forming a flow passage and the other may be provided with a flow passage opening, and they may be joined to each other by inserting the tubular portion into the flow passage opening while the gasket is sandwiched therebetween. Also in this case, the risk of water leakage can be reduced.

1. A gasket comprising:
a base having a loop shape;
a protrusion provided on the base, extending along the loop shape, and protruding toward a first member; and
a retainer formed on an inner periphery of the base and protruding from the inner periphery in an inward direction with respect to the loop shape,
wherein the gasket comprises an elastic material and is configured to join the first member and a second member, the first member and the second member forming a flow passage for liquid, and at least one of the first member or the second member comprises a ceramic material.

2. The gasket of claim 1, wherein the retainer is formed in a portion of the inner periphery.

3. The gasket of claim 1, wherein the base has the loop shape including a large curvature portion that has a larger curvature than a remaining portion, and
the retainer is provided only in the large curvature portion.

4. The gasket of claim 1, wherein the base has a substantially rectangular shape, and
the retainer is provided at least one of four corners of the substantially rectangular base and is absent in any portion other than the four corners.

5. The gasket of claim 1, wherein the protrusion comprises a first protrusion portion protruding toward the first member and a second protrusion portion protruding toward the second member, and
the second protrusion portion is provided adjacent to the ceramic member.

6. The gasket of claim 1, wherein in a state where the first member and the second member have been joined to each other via the gasket sandwiched therebetween, the retainer is received in a receiving portion formed in one of the first member or the second member and configured to receive therein the protrusion,
wherein the receiving portion is defined by an inner wall forming the flow passage, an outer wall surrounding an outer periphery of the inner wall, and a bottom directly connecting the inner wall to the outer wall, and
wherein a top end surface of the inner wall and a top end surface of the outer wall are butted against, and joined to, an end surface of one of the first member or the second member.

7. The gasket of claim 1, further including a projection in a portion, of the loop shape, in which the retainer is absent, the projection projecting in the inward direction with respect to the loop shape to be shorter in the inward direction than the retainer, wherein one of the first member or the second member is provided with a chamfered portion that corresponds to the portion, of the gasket, in which the projection is provided.

8. A sanitary comprising:
a gasket comprising:
a base having a loop shape;
a protrusion provided on the base, extending along the loop shape, and protruding toward a first member; and
a retainer formed on an inner periphery of the base and protruding from the inner periphery in an inward direction with respect to the loop shape,
wherein the gasket comprises an elastic material and is configured to join the first member and a second member, the first member and the second member forming a flow passage for liquid, and at least one of the first member or the second member comprises a ceramic material.
